(19) United States
(12) Patent Application Publication
(10) Pub. No.: US 2022/0227019 A1
(43) Pub. Date: Jul. 21, 2022

(54) CUTTER AND ADHESIVE CUTTING DEVICE

(71) Applicant: TRIPLE WIN TECHNOLOGY(SHENZHEN) CO.LTD., Shenzhen (CN)

(72) Inventor: FEI-FAN YU, Shenzhen (CN)

(21) Appl. No.: 17/324,640

(22) Filed: May 19, 2021

(30) Foreign Application Priority Data
Jan. 18, 2021 (CN) 202110060939.7

(51) Int. Cl. B26D 11/00; B26D 1/09

(52) U.S. Cl. CPC B26D 11/00; B26D 2210/00; B26D 1/095

(57) ABSTRACT

A cutter includes a base, a first blade arranged perpendicularly on the base, a second blade arranged on the base, and a third blade arranged on the base. The second blade is parallel to the first blade along a length direction and forms a first included angle with the base. The third blade is located on a side of the second blade away from the first blade. The third blade is parallel to the first blade along the length direction and forms a second included angle with the base. The second blade and the third blade are not parallel in the width direction. Cutting edges of the first blade, the second blade, and the third blade are in a same plane.

### FIELD

The present disclosure generally relates to a cutter, and more particularly to an adhesive cutting device and a cutter of the adhesive cutting device.

### BACKGROUND

In a pasting process of a conductive adhesive, two parallel adhesives are cut on a substrate with a single-blade cutter and then attached to a workpiece. However, such a pasting process may have a high cost and a low yield.

### BRIEF DESCRIPTION OF THE DRAWINGS

Implementations of the present disclosure will now be described, by way of embodiments, with reference to the attached figures.

FIG. 1 is a schematic diagram of a structure of a cutter according to an embodiment of the present disclosure.

FIG. 2 is a schematic diagram of a structure of an adhesive cutting device according to an embodiment of the present disclosure.

FIG. 3 is a bottom view of a pressing head shown in FIG. 2.

FIG. 4 is a schematic diagram of a structure of a workpiece and an adhesive.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

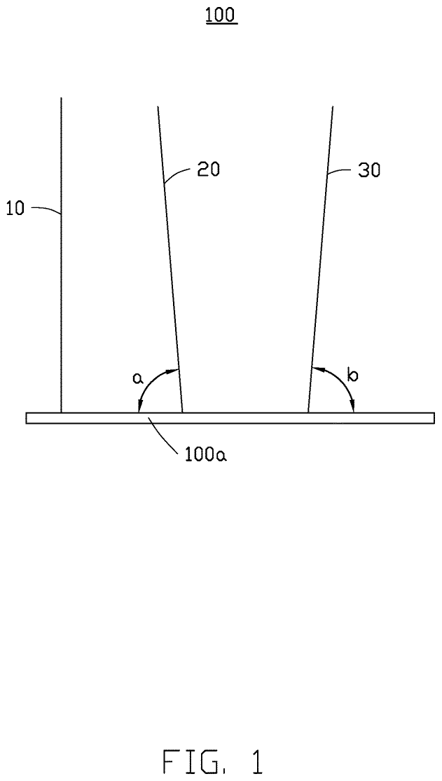

FIG. 1 shows an embodiment of a cutter 100 for cutting an adhesive. The cutter includes a base 100a, a first blade 10, a second blade 20, and a third blade 30. The first blade 10, the second blade 20, and the third blade 30 are arranged on the base 100a. The first blade 10 is substantially perpendicular to the base 100a along the cutting edge direction. The second blade 20 is substantially parallel to the first blade 10 along a length direction and forms a first included angle a with the base 100a along a width direction.

The third blade 30 is located on the side of the second blade 20 away from the first blade 10. The second blade 20 is located between the first blade 10 and the third blade 30. The third blade 30 is substantially parallel to the first blade 10 along the length direction and forms a second included angle b with the base 100a along the width direction. The second blade 20 and the third blade 30 are not parallel with each other in the width direction. Cutting edges of the first blade 10, the second blade 20, and the third blade 30 are in a same plane, so as to cut an adhesive at the same time. In one embodiment, the adhesive is an anisotropic conductive film adhesive, which is attached to a camera module of a mobile phone product after cutting.

In one embodiment, the first included angle a and the second included angle b are both 80 degrees, and a distance between the second blade 20 and the third blade 30 gradually increases in a direction away from the base 100a. In other embodiments, an angle range of the first included angle a and the second included angle b is greater than or equal to 60 degrees and less than or equal to 85 degrees, and the distance between the second blade 20 and the third blade 30 may gradually decrease in the direction away from the base 100a.

In use, a section of adhesive is formed between the first blade 10 and the second blade 20, a section of adhesive is formed between the second blade 20 and the third blade 30, and a section of adhesive is formed between the third blade 30 and the first blade 10 of a previous cutting. In other words, the cutter 100 can cut a continuous piece of adhesive into three sections. The first included angle a of the second blade 20 and the second angle b of the third blade 30 can prevent the adhesive from being excessively deformed due to extrusion during cutting, thereby improving yield.

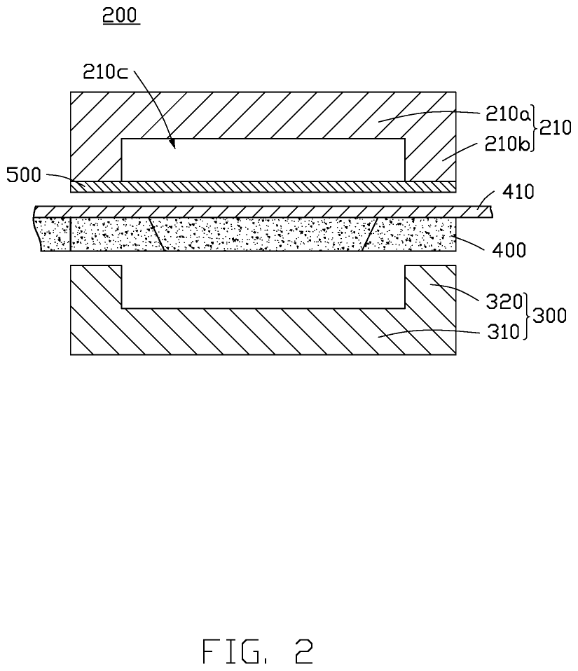

FIG. 2 shows an embodiment of an adhesive cutting device 200 for cutting an adhesive 400 and attaching the cut adhesive 400 to a workpiece 300. The adhesive cutting device 200 includes a pressing head 210 and the above-described cutter 100. One side of the adhesive 400 is adhered to a substrate 410. The cutter 100 only cuts the adhesive 400 on the substrate 410 and does not cut the substrate 410. The pressing head 210 is used to press down the substrate 410 to stick the cut adhesive 400 onto the workpiece 300.

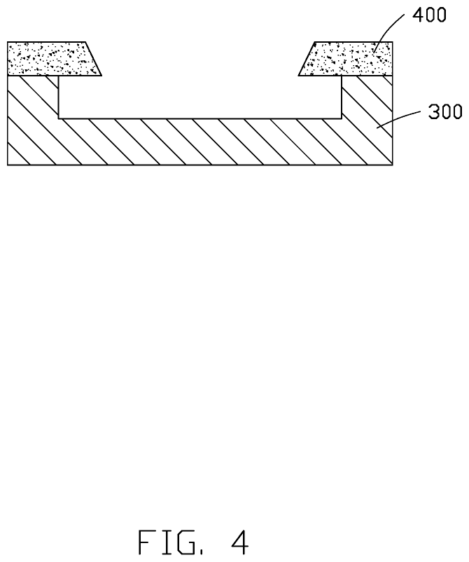

The pressing head 210 includes a connecting portion 210a and two pressing portions 210b. The two pressing portions 210b are located at two ends of the connecting portion 210a, respectively. The connecting portion 210a is used to drive the pressing portions 210b to press the substrate 410 to press the adhesive 400 onto the workpiece 300. Positions corresponding to the two pressing portions 210b are between cutting positions of the first blade 10 and the second blade 20, and between cutting positions of the third blade 30 and the first blade 10 of the previous cutting. When the adhesive 400 is attached to the workpiece 300 at the positions of the two pressing portions 210b, a middle portion of the adhesive 400 will be taken away by the substrate 410 when the substrate 410 is torn off, as shown in FIG. 4.

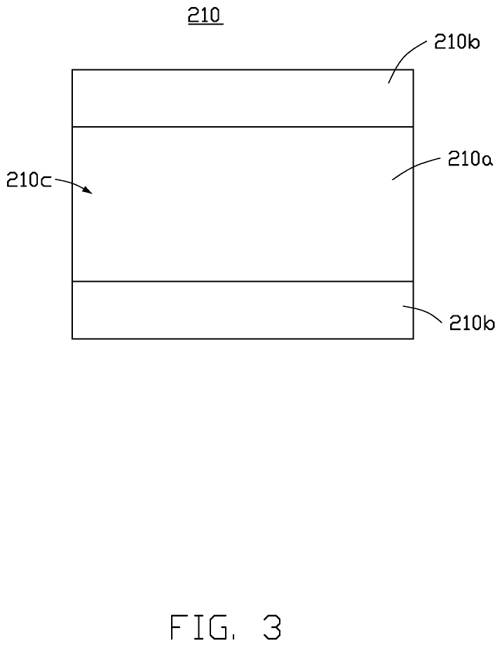

Referring to FIG. 3, the two pressing portions 210b are substantially rectangular and arranged in parallel. A gap 210c is arranged between the two pressing portions 210b, and a width of the gap 210c is greater than or equal to 4 mm and less than or equal to 5 mm. The gap 210c is for preventing the middle portion of the adhesive 400 from sticking to the workpiece 300.

In one embodiment, a buffer material 500 is arranged on a surface of the pressing portions 210b. The buffer material 500 is a flexible material for flexibly contacting the substrate 410.

In one embodiment, the workpiece 300 includes a main body 310 and two protrusions 320. The two protrusions 320 are arranged on two ends of the main body 310, respectively. Positions of the two pressing portions 210b correspond to positions of the two protrusions 320. The pressing portions 210b press the adhesive 400 onto a surface of the protrusions 320. The protrusions 320 are for preventing the middle portion of the adhesive 400 from contacting the workpiece 300.

In summary, the adhesive 400 is first cut on the substrate 410 into three pieces by the cutter 100. Then, the cut adhesives 400 are placed on the workpiece 300, and the pressing head 210 presses the substrate 410 to press the adhesive 400 onto the protrusions 320 of the workpiece 300. Finally, the substrate 410 is ripped off from the adhesive 400, and the middle portion of the adhesive 400 is taken away from the workpiece 300.

The cutter 100 can simultaneously cut the adhesive 400 into three pieces through the first cutter 10, the second cutter 20, and the third cutter 30, thereby achieving the purpose of reducing cutting costs. After the adhesive 400 is cut by the cutter 100, the adhesive 400 is pressed onto the workpiece 300 by the pressure head 210, and the middle portion of the adhesive 400 is removed, which improves efficiency and yield and reduces costs.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A cutter comprising:
a base;
a first blade arranged perpendicularly on the base;
a second blade arranged on the base, the second blade being parallel to the first blade along a length direction and forming a first included angle with the base; and
a third blade arranged on the base and located on a side of the second blade away from the first blade, the third blade being parallel to the first blade along the length direction and forming a second included angle with the base; wherein:
the second blade and the third blade are not parallel in a width direction; and
cutting edges of the first blade, the second blade, and the third blade are in a same plane.

2. The cutter of claim 1, wherein:
the first included angle is the same as the second included angle.

3. The cutter of claim 2, wherein:
the first included angle and the second included angle are 80 degrees.

4. The cutter of claim 1, wherein:
a distance between the second blade and the third blade gradually increases in a direction away from the base.

5. The cutter of claim 1, wherein:
a distance between the second blade and the third blade gradually decreases in a direction away from the base.

6. An adhesive cutting device comprising:
a cutter configured to cut an adhesive on a substrate; and
a pressure head configured to press the substrate to press the adhesive onto a workpiece, wherein:
the cutter comprises a base, a first blade, a second blade, and a third blade;
the first blade is arranged perpendicularly on the base;
the second blade is arranged on the base;
the second blade is parallel to the first blade along a length direction and forms a first included angle with the base;
the third blade is arranged on the base and located on a side of the second blade away from the first blade;
the third blade is parallel to the first blade along the length direction and forms a second included angle with the base;
the second blade and the third blade are not parallel in a width direction; and
cutting edges of the first blade, the second blade, and the third blade are in a same plane.

7. The adhesive cutting device of claim 6, wherein:
the pressure head comprises a connecting portion and two pressing portions;
the two pressing portions are arranged at two ends of the connecting portion, respectively;
the connecting portion is configured to drive the pressing portions to press the substrate to press the adhesive onto the workpiece.

8. The adhesive cutting device of claim 7, wherein:
the two pressing portions are arranged in parallel; and
a gap is arranged between the two pressing portions.

9. The adhesive cutting device of claim 7, wherein:
the pressing portions are provided with a buffer material; and
the buffer material flexibly contacts the substrate.

10. The adhesive cutting device of claim 8, wherein:
a width of the gap is greater than or equal to 4 mm and less than or equal to 5 mm.

11. The adhesive cutting device of claim 8, wherein:
the first included angle is the same as the second included angle.

12. The adhesive cutting device of claim 11, wherein:
the first included angle and the second included angle are 80 degrees.

13. The adhesive cutting device of claim 12, wherein:
a distance between the second blade and the third blade gradually increases in a direction away from the base.

14. The adhesive cutting device of claim 13, wherein:
a distance between the second blade and the third blade gradually decreases in a direction away from the base.
